(19) United States
(12) Patent Application Publication
(10) Pub. No.: US 2023/0071119 A1
(43) Pub. Date: Mar. 9, 2023

(54) CHANGE MONITORING AND DISPLAYING CHANGE ACTIVITY FOR A CLOUD COMPUTING ENVIRONMENT

(71) Applicant: Capital One Services, LLC, McLean, VA (US)

(72) Inventors: Christian Wolf, Arlington, VA (US); Daniel W. File, Baltimore, MD (US); Hanna Kim, Boyds, MD (US); Dawn Tepper, Arlington, VA (US)

(21) Appl. No.: 17/466,690

(22) Filed: Sep. 3, 2021

(51) Int. Cl. H04L 29/08; G06T 11/20; G06F 3/0481; G08B 5/22; G06N 20/00

(52) U.S. Cl. CPC H04L 67/36; G06T 11/206; G06F 3/0481; G08B 5/22; H04L 67/10; G06N 20/00

(57) ABSTRACT

Aspects described herein allow for systems and methods to monitor production changes to resources in a cloud computing environment and display the change activity via a change event dashboard. A change order monitoring application receives data from cloud computing audit logs to detect infrastructure changes and combines that data with application information to determine which application was affected. The change order monitoring application then uses a machine learning algorithm to cluster multiple change events together when it is likely that the change events were part of the same change. The change event dashboard visually displays real-time cloud computing application changes.

### FIELD OF USE

Aspects of the disclosure relate generally to change monitoring. More specifically, aspects of the disclosure may provide for monitoring and displaying change activity in a cloud computing environment using a machine learning algorithm.

### BACKGROUND

During a high severity technology incident, a technology operations command center must quickly determine the root cause of the incident and develop a plan to restore the affected services. Most high severity incidents are caused by application production changes, so it may be important to know whether and how the affected application and related applications have been changed.

Aspects described herein may address these and other problems, and generally improve the quality, efficiency, and speed of real-time cloud computing application changes for a technology operations team, providing a dashboard to visually display the real-time cloud computing application changes, and monitoring change activity in a cloud computing environment using a machine learning algorithm by providing a near real-time detective control to identify any potential unauthorized changes within the cloud computing environment, using the machine learning algorithm to group change events into change clusters.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Some aspects described herein may provide a computer-implemented method that includes the steps of: configuring a change order monitoring application and executing a machine learning algorithm based on the plurality of change events over a period of time. The change order monitoring application may receive a plurality of change events from one or more application services in a cloud computing environment. The machine learning algorithm may comprise: clustering the plurality of change events using a weighted event graph comprising the plurality of change events with one or more related connections between the plurality of change events; forming one or more change clusters over the period of time based on the clustering of the plurality of change events; aggregating the one or more change clusters over the period of time using one or more of the following: date, time range, change order number, employee identification number, application, or event name; displaying the one or more change clusters on a change event dashboard; determining one or more patterns of performance over the period of time based on the one or more change clusters, wherein the one or more patterns of performance indicates a potential correlation during the period of time between the one or more change clusters and the plurality of change events; and updating the machine learning algorithm based on the one or more patterns of performance. The change event dashboard may comprise an event view panel displaying each of the one or more change clusters over the period of time along a time axis.

According to some embodiments, the plurality of change events may comprise individual change events and application programming interface (API) calls. Additionally, the period of time may be a twenty-four-hour period. The machine learning algorithm may comprise a python implementation of a Louvain community detection algorithm. The weighted event graph may comprise weighted edges and the Louvain community detection algorithm assigns each vertex to a cluster to maximize a graph modularity. The change order monitoring application may create the weighted event graph with the plurality of change events as edges between the plurality of change events that are part of a same change event, and the Louvain community detection algorithm may partition the same change events into the change clusters. The edges may be determined by one or more edge variables that comprise a resource application identifier, a resource identifier, and an access key identifier. Further, the method may further comprise generating, using the machine learning algorithm and the change order monitoring application, an alert for one or more unauthorized changes and sending the alert to an implementer of the one or more unauthorized changes. Further, generating the alert may include automatically notifying the implementer of the one or more unauthorized changes and requesting additional information from the implementer of the one or more unauthorized changes regarding the unauthorized change. Additionally, the method may further comprise matching, by the change order monitoring application, the plurality of change events to the one or more application services in the cloud computing environment. Further, matching the plurality of change events to the one or more application services may be based on associating each change event with a corresponding taggable resource. Additionally, the method may further comprise matching, by the change order monitoring application, the plurality of change events to one or more change orders in the cloud computing environment. The change event dashboard may comprise a graphical display rectangle representing each of the aggregated change clusters over the period of time. When a user hovers over the graphical display rectangle, the change event dashboard may display a change event detail that comprises one or more of the following: date, time range, change order number, employee identification number, application, or event name. The change event dashboard may be updated in near real-time. Further, the method may comprise filtering, by the change order monitoring application, the change event dashboard based on one of the following: an account, an application, or an event name.

Additionally, other aspects described herein may provide a system to perform the following steps: configuring a change order monitoring application; matching, by the change order monitoring application, the plurality of change events to one or more change orders in the cloud computing environment; and executing a Louvain community detection algorithm based on the plurality of change events over a twenty-four-hour period of time. Further, the change order monitoring application may receive a plurality of change events from one or more application services in a cloud computing environment. Additionally, the Louvain community detection algorithm may comprise: clustering the plurality of change events using a weighted event graph comprising the plurality of change events with one or more related connections between the plurality of change events, wherein the weighted event graph comprises weighted edges and the Louvain community detection algorithm assigns each vertex to a cluster to maximize a graph modularity; forming one or more change clusters over the twenty-four-hour period of time based on the clustering of the plurality of change events; aggregating the one or more change clusters over the twenty-four-hour period of time using one or more of the following: date, time range, change order number, employee identification number, application, or event name; displaying the one or more change clusters on a change event dashboard; determining one or more patterns of performance over the twenty-four-hour period of time based on the one or more change clusters; and updating the Louvain community detection algorithm based on the one or more patterns of performance. Additionally, the change event dashboard may be updated in near real-time and comprises an event view panel displaying each of the one or more change clusters over the twenty-four-hour period of time along a time axis. The change event dashboard may comprise a graphical display rectangle representing each of the aggregated change clusters over the twenty-four-hour period of time. When a user hovers over the graphical display rectangle, the change event dashboard may display a change event detail that comprises one or more of the following: date, time range, change order number, employee identification number, application, or event name. The change event dashboard may filter based on one of the following: an account, an application, or an event name. Further, the one or more patterns of performance may indicate a potential correlation during the twenty-four-hour period of time between the one or more change clusters and the plurality of change events.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIGS. 2A-2C illustrate exemplary views of a change event dashboard according to one or more aspects of the disclosure;

FIG. 3 depicts a flow chart for a method of monitoring and displaying change activity in a cloud computing environment according to one or more aspects of the disclosure; and

FIGS. 4A-4C illustrate an exemplary change event dashboard and change order management application architecture according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for change management in a cloud environment and a change event dashboard that may visually display real-time cloud computing application changes. For example, the change event dashboard may visually display real-time cloud computing application changes for a technology operations team. When an application is affected by a technology incident, for example, the technology team can use the change event dashboard. The change event dashboard may monitor what cloud computing application programming interface (API) calls could have changed the affected application or any related applications. The change event dashboard may rely on data generated from a cloud computing monitoring application or a change order monitoring application (COMO).

For example, the data may include data generated by COMO such that COMO may be utilized to monitor all infrastructure changes within the cloud computing environment and production accounts. Additionally, COMO may check those changes against internal change logs to ensure that the changes were performed according to change management policy.

COMO may consume audit logs consisting of API calls from a cloud computing platform in real-time, such as for example, Amazon Web Services (AWS). COMO may also enrich those API calls with data from the cloud computing configuration services and the enterprise configuration management database. At the same time, API calls that were likely part of the same application change may be grouped together into communities using a machine-learning community detection algorithm. This data may then be aggregated and delivered to the change event dashboard. The data may be aggregated by, for example, a REST API. A REST API may be, for example, an application programming interface that conforms to the constraints of REST architectural style and allows for interaction with RESTful web services. REST stands for representational state transfer.

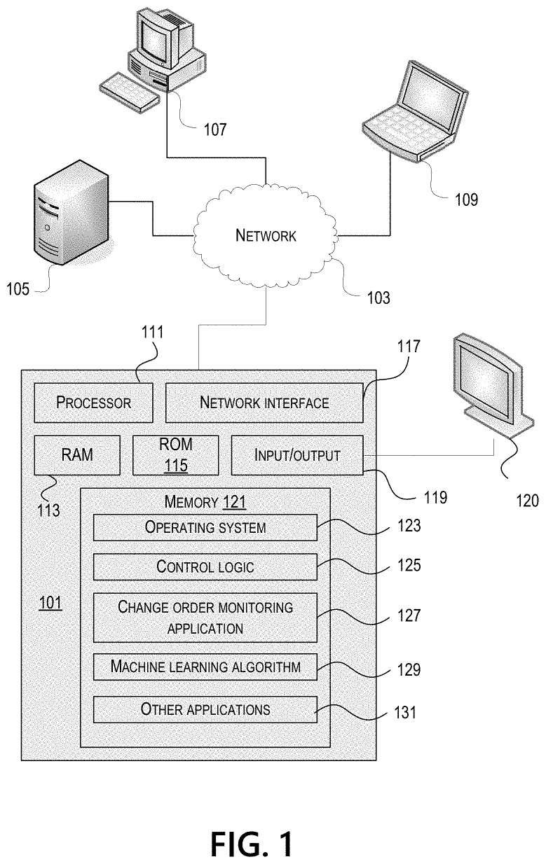

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, change order monitoring application (COMO) 127, machine learning software 129, and other applications 131. Control logic 125 may be incorporated in and may be a part of machine learning software 129. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or application or software 127, 129, 131.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to a method for monitoring change activity in a cloud environment.

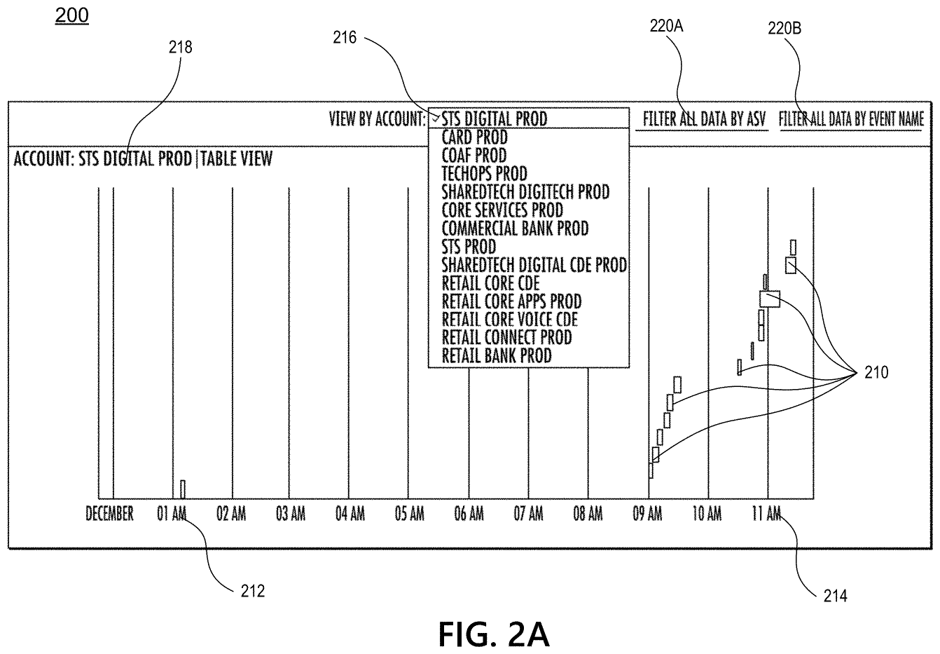

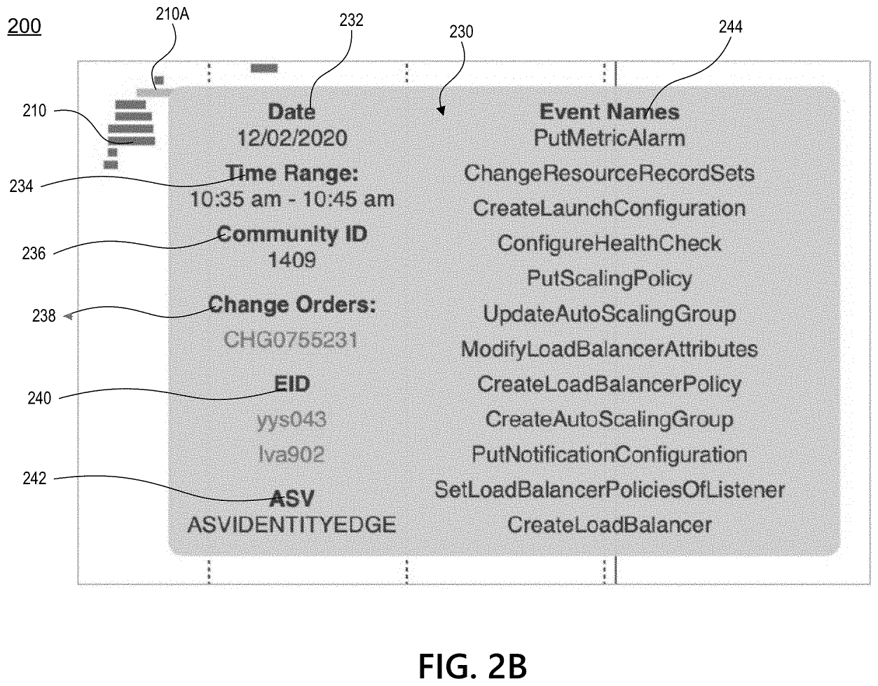

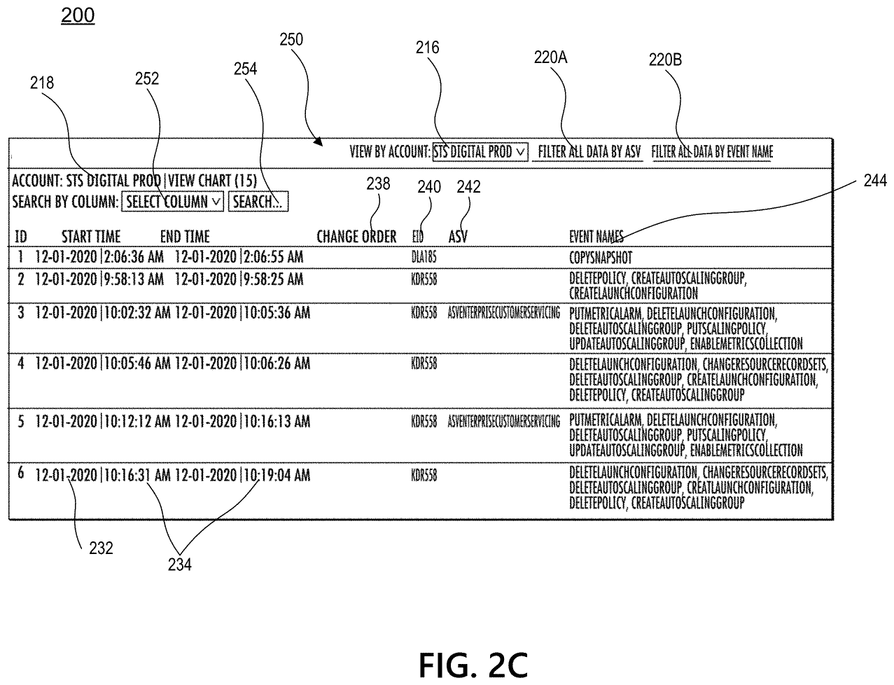

FIGS. 2A-2C illustrate exemplary views of a change event dashboard 200 used with the change order monitoring application (COMO) 127. The change event dashboard 200 may visually display real-time cloud computing application changes. When an application is affected by a technology incident, the change event dashboard 200 may be used to monitor what cloud computing API calls could have changed the affected applications or any other related applications. An advantage to using the actual API calls is that all cloud computing changes may be visible rather than just those which were properly planned. Additionally, the actual API calls may give the precise time at which a change was deployed and indicate which entity deployed the change.

As illustrated in FIG. 2A, the change event dashboard 200 may aggregate in real-time API calls into changes or change clusters as will be explained below using COMO 127. The advantage to using the actual real-time API calls is that all cloud computing changes may be visible rather than just those which were properly planned. Additionally, the actual API calls may give the precise time at which a change was deployed and indicate which entity deployed the change.

These changes or change clusters from the real-time API calls may be represented by change event icons 210 from a first event time 212 to a last event time 214. These changes or change clusters may also be represented over a period of time, such as a twenty-four-hour period or other periods of time without departing from this invention. The change event icons 210 may be any shape, such as a change event graphical displayed rectangle as illustrated in FIG. 2A. The change event icons 210 may be other shapes as well, such as circles, triangles, squares, stars, diamonds, etc. An initial default view of the change event dashboard 200 may show data from the first account listed in the account dropdown menu 216. As illustrated in the account dropdown menu 216, various accounts may be listed and eligible for selection. When selecting a new account from the account dropdown menu 216, the change event dashboard 200 may redraw itself using the real-time data from that new selected account. The account name 218 may also be listed on the change event dashboard 200. The change event dashboard 200 may also include one or more filter selection boxes 220A, 220B. A user may be able to filter data presented in the change event dashboard 200 using the one or more filter selection boxes 220A, 220B. The one or more filter selections boxes 220A, 220B may filter the data presented in the change event dashboard 200 based on one or more of the following: an account/account name, an application, and/or an event name. The one or more filter selections boxes 220A, 220B may also include autocomplete filter functionality

FIG. 2B illustrates a change event detail 230 associated with a specific change event icon 210 that is included with the change event dashboard 200. When a user hovers over a selected change event icon 210A or change event graphically displayed rectangle (as illustrated in FIG. 2B), the change event dashboard may display the change event detail 230. The change event detail 230 may include one or more of the following details about the specific selected change event icon 210A: date 232, time range 234, group identification number (or community ID) 236, change order number 238, employee identification number (or EID) 240, application (or ASV) 242, and/or event name 244. The change event detail 230 may also include links to one or more of the specific details of date 232, time range 234, group identification number 236, change order number 238, employee identification number 240, application 242, and/or event name 244. For example, the change event detail 230 may allow the user to link to an employee profile page by clicking on the employee identification number 240. In another example, the change event detail 230 may allow the user to link to a change order by clicking on the change order number 238.

FIG. 2C illustrates an example table view 250 of the change event dashboard 200. The user may be able to select the view chart selection 252 (or similar) in order to view the table view 250 for a selected account 218. The table view 250 may include various columns, such as those displayed in the change event detail 230, such as: date 232, time range (or start time and end time) 234, change order number 238, employee identification number (or EID) 240, application (or ASV) 242, and/or event name 244. The user may be able to sort via various columns in a sort column filter 252. The user may also be able to search the table view 250 using a search box 254. The search box 254 may include an autocomplete feature.

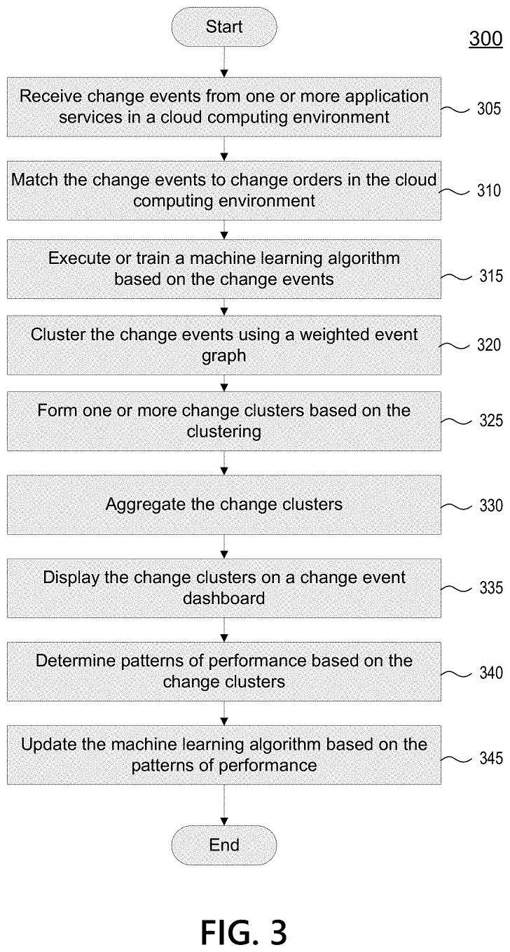

FIG. 3 illustrates an example method 300 for monitoring change activity in a cloud environment and displaying that change activity in accordance with one or more aspects described herein. Method 300 may be implemented by a suitable computing system as described herein. For example, method 300 may be implemented by any suitable computing environment by a computing device and/or combination of computing devices, such as computing devices 101, 105, 107, and 109 of FIG. 1. Method 300 may be implemented in suitable program instructions, such as the change order monitoring application 127, the machine learning algorithm 129, and the change event dashboard 200.

At step 305, the COMO 127 and the change event dashboard 200 may receive change events from one or more application services in a cloud computing environment. COMO 127 may receive change events and/or audit logs from various sources. For example, COMO 127 may use various cloud computing environments, such as for example, AWS CloudTrail and Config data which are generated by AWS, Azure, and/or other comparable cloud computing environments. COMO 127 may also use and change data through one more various service models that define, structure, and automate the flow of work (e.g. ServiceNow application programming interface (API) and Snowflake for business applications (BAPP)) to application services (ASV) mapping and performing group tables. All COMO 127 data, both sources and output, may be registered in a cloud server/computer for dataset registration and metadata capture. COMO 127 may rely on the completeness and accuracy of the cloud computing environment audit logs and change events.

At step 310, the COMO 127 and the change event dashboard 200 may match the change events to one or more change orders. Additionally, the COMO 127 and the change event dashboard 200 may match the change events to the one or more application services. In order for an event to be matched to a change order, three example criteria may be reviewed: 1. The event application (ASV) must match the change order configuration item application (ASV) through the CMDB mapping (the event must affect the ASV/application tag listed in the change order); 2. The eventTime must be within the change window as defined by the planned start/end values in one more various service models that define, structure, and automate the flow of work (e.g. ServiceNow) (the event must have occurred within the change window for the change order); 3. The individual implementing the change must belong to the performing group for the change order (the event must have been performed by a member of the performing group). The precise logic for an event to be within the change order window is event time may be after a planned start time less one hour, and event time may be before a planned end time plus one hour.

At step 315, the COMO 127 and the change event dashboard 200 may execute or train a machine learning algorithm based on the change events. When a change is implemented, dozens of change events may be recorded by CloudTrail. In some embodiments, COMO 127 is configured to produce a single alert for each unauthorized change. Therefore, COMO 127 attempts to cluster together events that were probably part of the same change, and only sends one event per cluster. COMO 127 may use a python implementation of the Louvain community detection algorithm 129 for the event clustering. The Louvain community detection algorithm 129 is a machine learning algorithm that automatically defines event clusters. For example, Louvain community detection algorithm 129 may define the events as vertices (nodes) in a graph (network); put an edge (connection) between two vertices that could be part of the same change activity; assign a weight (number) that reflects the likelihood that the events are part of the same change activity.

At step 320, the COMO 127 and the change event dashboard 200 may cluster the change events using a weighted event graph. For example, the Louvain community detection algorithm 129 takes a weighted graph (i.e. a graph with weighted edges) and attempts to assign each vertex to a cluster so that the graph metric modularity is maximized. Graph modularity measures the density of links within a cluster versus the density of links between clusters.

Specifically, modularity compares the sum of weights within clusters compared to the sum of weights between clusters. Modularity (Q) is the objective function that must be maximized:

$$Q = {\sum }_{i , j} [ {A}_{ij} - \frac{{k}_{i} {k}_{j}}{2 m} ] δ ( {c}_{i} , {c}_{j} )$$

i, j are nodes
m is the total number of connections
Aᵢⱼ is the weight of the connection between i and j
kᵢ is the sum of weights of connections coming from i
δ (cᵢ, cⱼ)=1 if i and j are in the same cluster, 0 otherwise

Larger modularity implies more connected and better defined clusters. This may be a stochastic algorithm and may not produce the same modularity or clusters if repeated.

At step 330, and related to step 330, the COMO 127 and the change event dashboard 200 may aggregate the one or more clusters from the weighted event graph. The COMO 127 and the change event dashboard 200 may create a graph with events as vertices and edges between events that may be part of the same change, and the Louvain machine learning algorithm 129 may partition the events into clusters. Edges may be determined by three edge variables: resource application identifier, resource identifier, and access key identifier. Each pair of events may have as many as three edges connecting them: one edge for each of the three edge variables for which the events share a common value provided that the time between the events is less than the cutoff for that edge variable. Two events (vertices/nodes) may be connected when the events are of the same application tag (within time cutoff), same resource (within time cutoff), or same access key identifier (within time cutoff). The connections may be weighted such that the closer together in time have larger weights. Specifically, the weight of an edge may be determined by the time between the events and two weight parameters (w1, w2) defined for each edge variable. The formula for the weight between two events that are t seconds apart may be calculated as w=w1/(t+w2).

At step 335, the COMO 127 may display the change clusters on the change event dashboard 200. The change event dashboard 200 may visually display real-time cloud computing application changes. The change event dashboard 200 may aggregate in real-time API calls into changes or change clusters. These changes or change clusters may be represented by change event icons 210 or a graphical displayed rectangle. The change event dashboard 200 may also include the table view 250 that may include various columns, such as: date 232, time range 234, group identification number 236, change order number 238, employee identification number 240, application 242, and/or event name 244. The change event dashboard 200 may also include a change event detail 230 associated with a specific change event icon 210. When a user hovers over a selected change event icon 210A or change event graphically displayed rectangle, the change event dashboard may display the change event detail 230. The change event detail 230 may include one or more of the following details about the specific selected change event icon 210A: date 232, time range 234, group identification number 236, change order number 238, employee identification number 240, application 242, and/or event name 244.

At step 340, the COMO 127 and the change event dashboard 200 may determine patterns of performance based on the change clusters. Further, at step 345, the COMO 127 and the change event dashboard 200 may update the machine learning algorithm 129 based on the patterns of performance from the change clusters.

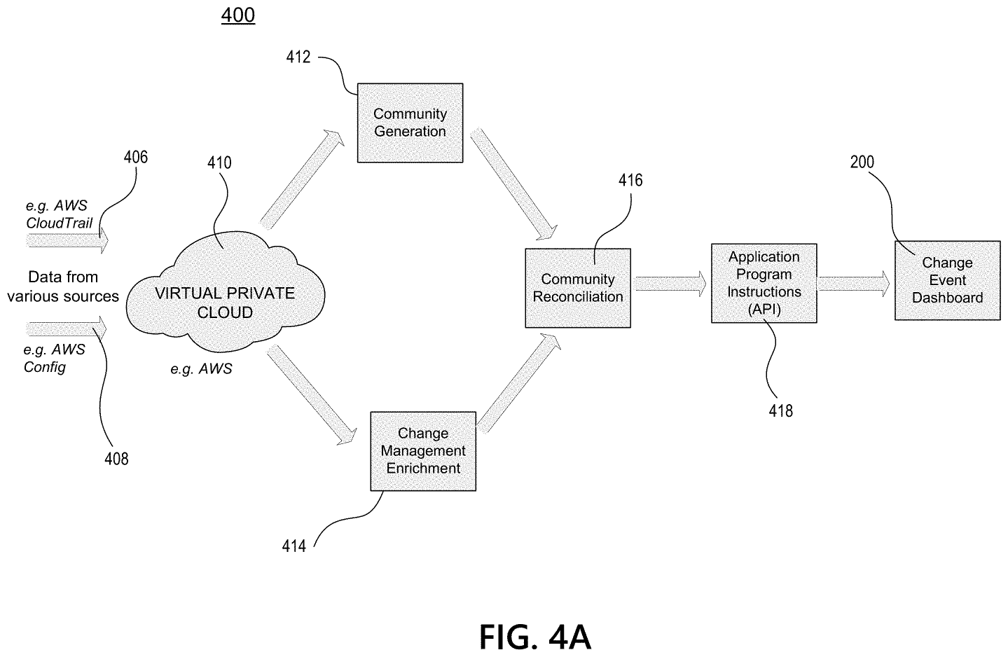

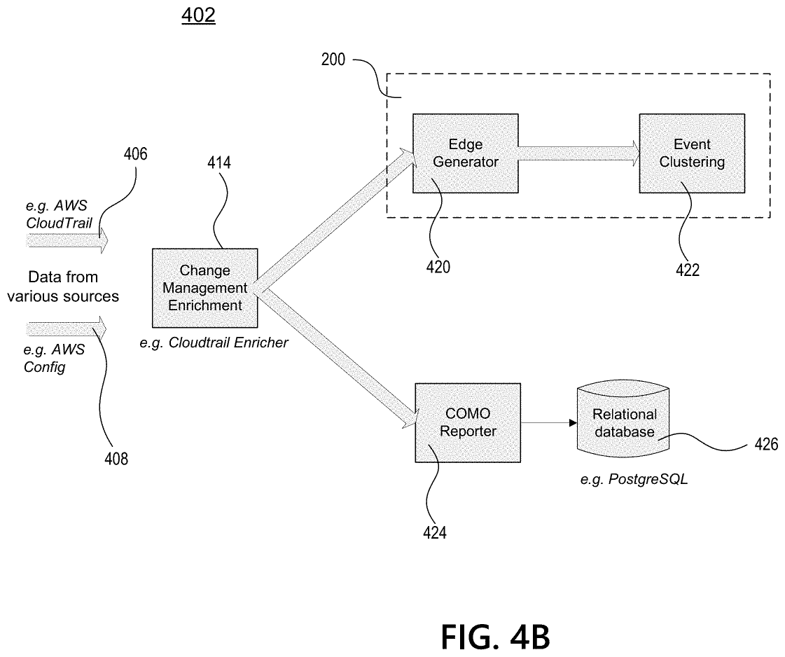

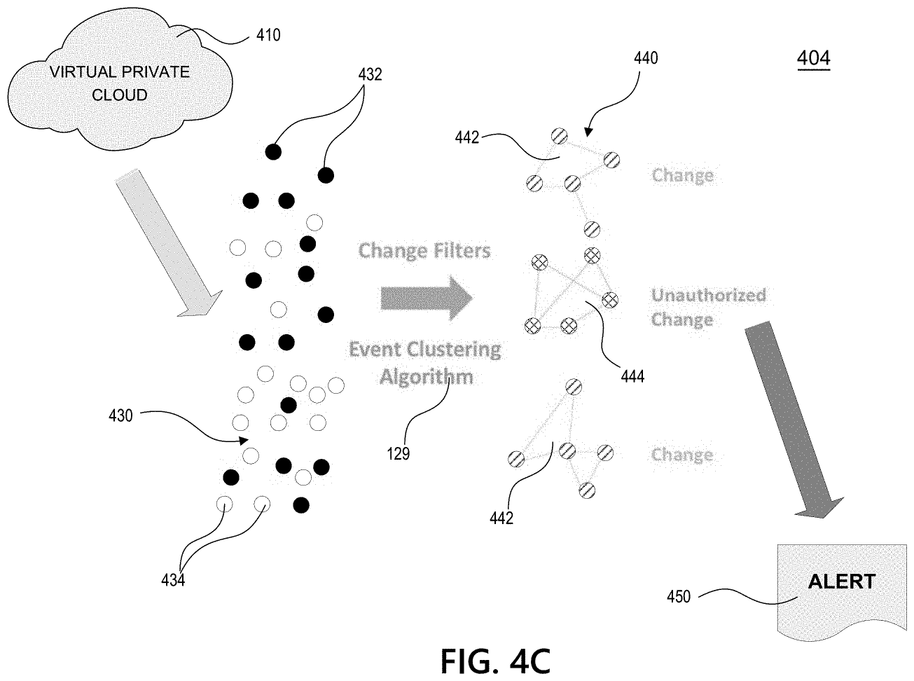

FIGS. 4A-4C illustrate an example change event dashboard 200 and COMO 127 architecture. The representation illustrated in FIGS. 4A-4C may be modified in accordance with the description as detailed above. FIGS. 4A-4C illustrate an exemplary data flow and data movement for a change event dashboard 200 and an exemplary COMO 127 architecture.

Specifically, FIGS. 4A and 4B illustrate exemplary data flow 400, 402 for the change event dashboard 200. FIG. 4C illustrates an exemplary representation of the COMO 127 change monitoring overview 404. The mention and discussion of specific tools or services are an example where the cloud provider is AWS. Other cloud computing environments (e.g. Azure and/or other comparable cloud computing environments) may be utilized and those specific tools or services may be utilized without departing from the example embodiments.

As illustrated in FIGS. 4A and 4B, event data may be pushed by various data sources, such as data from event history and change audit logs 406 (e.g. AWS CloudTrail) and data from monitoring and recording resource configurations 408 (e.g. AWS Config) to a virtual private cloud 410. The virtual private cloud 410 may output audit logs to a data storage resource. From there, the data and change events may be sent to a community generation 412 or a change management enrichment 414. FIG. 4B specifically details the data flow and architecture 402 related to the change management enrichment 414.

As illustrated in FIG. 4A, the data from the virtual private cloud 410 may be then directed to the change management enrichment 414 that may be running one or more machine learning algorithms 129. The change management enrichment 414 running one or more machine learning algorithms 129 may provide data munging, parsing, and machine learning models. As was described above, the machine learning algorithm 129 may be a Louvain community detection algorithm. The machine learning algorithm 129 may be configured to enable one or more of the following: filter change events, flatten data and match to configuration data, store events data in a database, and match cluster data. The machine learning algorithm 129 for community detection may create an event graph that includes events through individual API calls as vertices, with the relationship between those events forming the edges, such as resource application identifier, resource identifier, and access key identifier. The events, vertices, and edges may be weighted by proximity in time. For community detection, the machine learning algorithm may partition the vertices into communities so that each event community or cluster is highly connected, leaving very few connections between the event communities or clusters.

The community generation 412 and change management enrichment 414 may send the various event communities to the community reconciliation 416. The event data may then be aggregated and delivered to the change event dashboard 200. The data may be aggregated by an application program instructions (API) 418, for example, a REST API. A REST API may be, for example, an application programming interface that conforms to the constraints of REST architectural style and allows for interaction with RESTful web services. REST stands for representational state transfer.

FIG. 4B further illustrates the specific data flow and architecture 402 for the change event dashboard 200. As illustrated in FIG. 4B, the change order monitoring application (COMO) 127 and the change event dashboard 200 may read the data from the event history and change audit logs 406 (e.g. AWS CloudTrail) and the data from monitoring and recording resource configurations 408 (e.g. AWS Config) and flatten the data from the event history and change audit logs 406 (e.g. AWS CloudTrail) and the data from monitoring and recording resource configurations 408 (e.g. AWS Config) from the virtual private cloud 410. The change order monitoring application (COMO) 127 and the change event dashboard 200 may direct the data from the change management enrichment 414 that may be running one or more machine learning algorithms 129 for edge generation 420 and event clustering 422.

For edge generation 420, the change event dashboard 200 may create a graph with change events as vertices and edges between events that may be part of the same change. For event clustering 422, a machine learning algorithm 129 may partition the events into clusters. The edge generation 420 may execute or run during a specified timeline, for example every five minutes. During this edge generation 420, the change event dashboard 200 may create a sliding window for a given view on the change event dashboard 200. Edges may be determined by three edge variables: resource application identifier, resource identifier, and access key identifier. Each pair of events may have as many as three edges connecting them: one edge for each of the three edge variables for which the events share a common value provided that the time between the events is less than the cutoff for that edge variable. Two events (vertices/nodes) may be connected when the events are of the same application tag (within time cutoff), same resource (within time cutoff), or same access key identifier (within time cutoff). The connections may be weighted, such that the closer together in time have larger weights. Specifically, the weight of an edge may be determined by the time between the events and two weight parameters (w1, w2) defined for each edge variable. The formula for the weight between two events that are t seconds apart may be calculated as w=w1/(t+w2).

The change order monitoring application (COMO) 127 and the change event dashboard 200 may also write the event data via a COMO reporter 424 to a relational database 426, for example PostgreSQL. The relational database 426 may be a relational database management system.

FIG. 4C illustrates an example change monitoring overview 404 for a change order monitoring application (COMO) 127 to be used with the change event dashboard 200. COMO 127 is an application that monitors change activity in a cloud computing environment 410 that may monitor several hundred million events every day across the cloud computing environment 410. COMO 127 monitors change events 430 recorded in the cloud computing environment 410. The change events 420 recorded in the cloud computing environment 410 may be either change events 432 or noise events/non-change events 434. The change events 430 are generally those events that are associated with a change order. COMO 127 separates and filters the change events 432 and the non-change events 434 as illustrated at 430. COMO 127, using an event clustering algorithm or a machine learning clustering algorithm 129 as illustrated at 440, then clusters the large number of change events into meaningful and similar groups of changes so that the change clusters can be compared to change orders. The change clusters may be compared to change orders based on various variables, such as change identifier or resource tag, change time, and performance group. Any change cluster that has a match to a change order is an authorized change 442. A change cluster that does not have a match is a potential unauthorized change 444. COMO 127 then may send an alert 450 in the form of a message or notification to an implementer of the change or the application team for validation. Implementers and application teams may respond through a web form in the alert message or notification with whether there is a change order and additional details. Based on the implementer or application team's response, it may be determined whether it is an authorized change 442 or a change violation or unauthorized change 444. COMO 127 may monitor several types of change violations. COMO 127 may then send the data to the change event dashboard 200.

The events monitored by COMO 127 may come from various data sources in a cloud computing environment. The mention and discussion of specific tools or services are an example where the cloud provider is AWS. Other cloud computing environments (e.g. Azure and/or other comparable cloud computing environments) may be utilized and those specific tools or services may be utilized without departing from the example embodiments. For example, the events may come from AWS CloudTrail, a service managed by AWS to provide audit logs for activity. CloudTrail may track changes to AWS resources such as computing (e.g. EC2), networking (e.g. autoscaling and load balancing), relational and no-SQL databases, identity and access management, and managed services (e.g. AWS Lambda).

When a change event cannot be matched to a corresponding change order, COMO 127 flags it as a potential unauthorized change. Potential unauthorized changes may appear on dashboards accessible to application teams, leadership, and other stakeholders. In addition, the individual who initiates a potential unauthorized change event may be automatically notified and may need to respond with more information about the change such as the change order or incident number.

COMO 127 may be a deterministic application: events are filtered and matched to change orders according to business rules. However, in some embodiments, at least one aspect of COMO 127 is either non-deterministic or inferential. A typical production change generates many events in CloudTrail. If these events can be matched to a change order, then the changes are naturally grouped together; however, in the case of a potential unauthorized change there may be several dozen events triggering notifications for what is essentially one change. To avoid sending multiple alerts (via email or using messaging applications) for a single potential unauthorized change, COMO 127 may use a machine learning algorithm 129, such as the Louvain community detection algorithm, to group events into change clusters. One message or notification alert may then be generated from each cluster containing a potential unauthorized change.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied, in whole or in part, in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
configuring a change order monitoring application, wherein the change order monitoring application receives a plurality of change events from one or more application services in a cloud computing environment; and
execute a machine learning algorithm based on the plurality of change events over a period of time, wherein executing the machine learning algorithm comprises:
clustering the plurality of change events using a weighted event graph comprising the plurality of change events with one or more related connections between the plurality of change events;
forming one or more change clusters over the period of time based on the clustering of the plurality of change events;
aggregating the one or more change clusters over the period of time using one or more of the following: date, time range, change order number, employee identification number, application, or event name;
displaying the one or more change clusters on a change event dashboard, wherein the change event dashboard comprises an event view panel displaying each of the one or more change clusters over the period of time along a time axis;
determining one or more patterns of performance over the period of time based on the one or more change clusters, wherein the one or more patterns of performance indicates a potential correlation during the period of time between the one or more change clusters and the plurality of change events; and
updating the machine learning algorithm based on the one or more patterns of performance.

2. The method of claim 1, wherein the plurality of change events comprise individual change events and application programming interface (API) calls.

3. The method of claim 1, wherein the period of time is a twenty-four-hour period.

4. The method of claim 1, wherein the machine learning algorithm comprises a python implementation of a Louvain community detection algorithm.

5. The method of claim 4, wherein the weighted event graph comprises weighted edges and the Louvain community detection algorithm assigns each vertex to a cluster to maximize a graph modularity.

6. The method of claim 4, wherein the change order monitoring application creates the weighted event graph with the plurality of change events as edges between the plurality of change events that are part of a same change event, and the Louvain community detection algorithm partitions the same change events into the change clusters, wherein the edges are determined by one or more edge variables that comprise a resource application identifier, a resource identifier, and an access key identifier.

7. The method of claim 1, further comprising:
generating, using the machine learning algorithm and the change order monitoring application, an alert for one or more unauthorized changes and sending the alert to an implementer of the one or more unauthorized changes, wherein generating the alert includes automatically notifying the implementer of the one or more unauthorized changes and requesting additional information from the implementer of the one or more unauthorized changes regarding the unauthorized change.

8. The method of claim 1, further comprising:
matching, by the change order monitoring application, the plurality of change events to the one or more application services in the cloud computing environment, wherein matching the plurality of change events to the one or more application services is based on associating each change event with a corresponding taggable resource.

9. The method of claim 1, further comprising:
matching, by the change order monitoring application, the plurality of change events to one or more change orders in the cloud computing environment.

10. The method of claim 1, wherein the change event dashboard comprises a graphical display rectangle representing each of the aggregated change clusters over the period of time, wherein when a user hovers over the graphical display rectangle, the change event dashboard displays a change event detail that comprises one or more of the following: date, time range, change order number, employee identification number, application, or event name.

11. The method of claim 1, wherein the change event dashboard is updated in near real-time.

12. The method of claim 1, further comprising:
filtering, by the change order monitoring application, the change event dashboard based on one of the following: an account, an application, or an event name.

13. A system comprising:
a database configured to store a plurality of change events from one or more application services in a cloud computing environment;
one or more processors; and
memory storing instructions that, when executed by the one or more processors, cause the one or more processors to:
receive, by a change order monitoring application executing on the one or more processors, the plurality of change events;
match the plurality of change events to one or more change orders in the cloud computing environment;
execute a machine learning algorithm based on the plurality of change events over a twenty-four-hour period of time, wherein the instructions cause the change order monitoring application to execute the machine learning algorithm by causing the change order monitoring application to:
cluster the plurality of change events using a weighted event graph comprising the plurality of change events with one or more related connections between the plurality of change events;
form one or more change clusters based on the clustering of the plurality of change events;
aggregate the one or more change clusters over the twenty-four-hour period of time using one or more of the following: date, time range, change order number, employee identification number, application, or event name;
display the one or more change clusters on a change event dashboard, wherein the change event dashboard comprises an event view panel displaying each of the one or more change clusters over the twenty-four-hour period of time along a time axis, wherein the change event dashboard comprises a graphical display rectangle representing each of the aggregated change clusters over the twenty-four-hour period of time, wherein when a user hovers over the graphical display rectangle, the change event dashboard displays a change event detail that comprises one or more of the following: date, time range, change order number, employee identification number, application, or event name;
determine one or more patterns of performance based on the one or more change clusters, wherein the one or more patterns of performance indicates a potential correlation between the one or more change clusters and the plurality of change events; and
update the machine learning algorithm based on the one or more patterns of performance.

14. The system of claim 13, wherein the machine learning algorithm comprises a python implementation of a Louvain community detection algorithm and the weighted event graph comprises weighted edges and the Louvain community detection algorithm assigns each vertex to a cluster to maximize a graph modularity.

15. The system of claim 14, wherein the change order monitoring application creates the weighted event graph with the plurality of change events as edges between the plurality of change events that are part of a same change event, and the Louvain community detection algorithm partitions the same change events into the change clusters, wherein the edges are determined by one or more edge variables that comprise a resource application identifier, a resource identifier, and an access key identifier.

16. The system of claim 13, wherein the change event dashboard is updated in near real-time.

17. The system of claim 13, further comprising:
filtering, by the change order monitoring application, the change event dashboard based on one of the following: an account, an application, or an event name.

18. One or more non-transitory media storing instructions that, when executed by one or more processors, cause the one or more processors to perform steps comprising:
configuring a change order monitoring application, wherein the change order monitoring application receives a plurality of change events from one or more application services in a cloud computing environment;
matching, by the change order monitoring application, the plurality of change events to one or more change orders in the cloud computing environment; and
executing a Louvain community detection algorithm based on the plurality of change events over a twenty-four-hour period of time, wherein the Louvain community detection algorithm comprises:
clustering the plurality of change events using a weighted event graph comprising the plurality of change events with one or more related connections between the plurality of change events, wherein the weighted event graph comprises weighted edges and the Louvain community detection algorithm assigns each vertex to a cluster to maximize a graph modularity;
forming one or more change clusters over the twenty-four-hour period of time based on the clustering of the plurality of change events;
aggregating the one or more change clusters over the twenty-four-hour period of time using one or more of the following: date, time range, change order number, employee identification number, application, or event name;
displaying the one or more change clusters on a change event dashboard, wherein the change event dashboard is updated in near real-time and comprises an event view panel displaying each of the one or more change clusters over the twenty-four-hour period of time along a time axis, wherein the change event dashboard comprises a graphical display rectangle representing each of the aggregated change clusters over the twenty-four-hour period of time, wherein when a user hovers over the graphical display rectangle, the change event dashboard displays a change event detail that comprises one or more of the following: date, time range, change order number, employee identification number, application, or event name, wherein the change event dashboard filters based on one of the following: an account, an application, or an event name;
determining one or more patterns of performance over the twenty-four-hour period of time based on the one or more change clusters, wherein the one or more patterns of performance indicates a potential correlation during the twenty-four-hour period of time between the one or more change clusters and the plurality of change events; and
updating the Louvain community detection algorithm based on the one or more patterns of performance.

19. The one or more non-transitory media storing instructions of claim 18, when executed by the one or more processors, further cause the change order monitoring application to perform steps comprising: generating, using the Louvain community detection algorithm and the change order monitoring application, an alert for one or more unauthorized changes and sending the alert to an implementer of the one or more unauthorized changes, wherein generating the alert includes automatically notifying the implementer of the one or more unauthorized changes and requesting additional information from the implementer of the one or more unauthorized changes regarding the unauthorized change.

20. The one or more non-transitory media storing instructions of claim 18, wherein the change order monitoring application creates the weighted event graph with the plurality of change events as edges between the plurality of change events that are part of a same change event, and the Louvain community detection algorithm partitions the same change events into the change clusters, wherein the edges are determined by one or more edge variables that comprise a resource application identifier, a resource identifier, and an access key identifier.
